(19) United States
(12) Patent Application Publication
(10) Pub. No.: US 2021/0068352 A1
(43) Pub. Date: Mar. 11, 2021

(54) MODULAR, SCALABLE, AND CONFIGURABLE PLANTER BOX

(71) Applicant: Matthew Moore, South Jordan, UT (US)

(72) Inventor: Matthew Moore, South Jordan, UT (US)

(21) Appl. No.: 16/987,389

(22) Filed: Aug. 6, 2020

Related U.S. Application Data
(60) Provisional application No. 62/883,450, filed on Aug. 6, 2019.

(51) Int. Cl. A01G 9/02; B65D 6/26; B65D 6/02

(52) U.S. Cl. CPC A01G 9/027; B65D 7/06; B65D 7/30

(57) ABSTRACT

A modular and scalable box/container system comprises square or rectangular panels having holes on all four sides, an extension-flat-angled connector for extending a vertically-oriented panel by securing it to another vertically-oriented panel, a corner-flat-angled connector for securing two vertical panels in a square corner configuration, a corner-angled-angled connector for securing a vertically-oriented panel to a horizontally-oriented panel, and an extension-angled-angled connector for extending a horizontally-oriented panel by securing it to another horizontally-oriented panel. The system further comprises bolts and nuts, or other hardware, for securing panels to connectors.

### BACKGROUND OF THE INVENTION

Metal planter boxes are beautiful and durable. However, they cannot be made by hand or with tools that a homeowner customarily has on hand. Cutting and bending metal for planter boxes generally requires machines that are large, expensive, sophisticated, and/or dangerous. In light of these circumstances, metal planter boxes often must be custom made, delivered, and/or installed, and cannot be modified after manufacturing. What is needed is a metal planter box design that is modular, scalable, and configurable.

### BRIEF SUMMARY OF THE INVENTION

A novel scalable modular system for planter boxes and other boxes includes side panels, bottom panels, side-corner connectors, bottom-corner connectors, extension connectors, and screws or other securement means.

### BRIEF DESCRIPTION OF THE DRAWINGS

FIG. 1 shows a front view of an exemplary panel.

FIG. 2 shows an elevated angle view of an exemplary panel.

FIG. 3 shows a front view of an exemplary extension-flat-angled connector.

FIG. 4 shows an elevated angle view of an exemplary extension-flat-angled connector.

FIG. 5 shows an elevated angle view of an exemplary corner-flat-angled connector.

FIG. 6 shows an elevated angle view, from the back, of the exemplary corner-flat-angled connector shown in FIG. 5.

FIG. 7 shows an elevated angle view of an exemplary corner-angled-angled connector.

FIG. 8 shows a front view of an exemplary extension-angled-angled connector.

FIG. 9 shows an elevated angle view of an exemplary extension-angled-angled connector.

FIG. 10 shows an elevated angle view of an exemplary box, without bolts and nuts, formed from the components disclosed herein. The shading identifies internal panel surfaces.

FIG. 11 shows an elevated angle view of an exemplary box, without bolts and nuts, formed from the components disclosed herein. The shading identifies internal panel surfaces.

FIG. 12 shows an elevated angle view of an exemplary box, including bolts and nuts, formed from the components disclosed herein. The shading identifies internal panel surfaces.

FIG. 13 shows a top-down view (showing the inside surface of the bottom of the box) of a box, including bolts and nuts, formed from the components disclosed herein. The shading identifies internal panel surfaces.

FIG. 14 shows an elevated angle view of an extended box, including bolts and nuts, formed from the components disclosed herein. The shading identifies internal panel surfaces.

FIG. 15 shows an elevated angle view of an extended box, including bolts and nuts, formed from the components disclosed herein. The shading identifies internal panel surfaces.

FIG. 16 shows a top-down view (showing the inside surface of the bottom of the box) of an extended box, including bolts and nuts, formed from the components disclosed herein. The shading identifies internal panel surfaces.

FIG. 17 shows an angle view from of the bottom side of an extended box, including bolts and nuts, formed from the components disclosed herein.

### DETAILED DESCRIPTION OF THE INVENTION

This application claims priority to U.S. Provisional Application No. 62/883,450, titled “Modular Scalable, and Configurable Planter Box,” and filed on Aug. 6, 2019, and which is incorporated herein by reference in its entirety.

A modular, scalable, and configurable planter box system may comprise side panels, bottom panels, and connectors.

Table of Reference Numbers from Drawings:

The following table is for convenience only, and should not be construed to supersede any potentially inconsistent disclosure herein.

| Reference Number | Description |
|---|---|
| 110 | panel |
| 120 | extension-flat-angled connector |
| 130 | corner-flat-angled connector |
| 140 | corner-angled-angled connector |
| 150 | extension-angled-angled connector |
| 160 | bolt-nut assembly |
| 180 | holes for bolts |

Although this disclosure is directed toward a planter box, the invention disclosed herein may apply to other types of boxes, storage units, or containers.

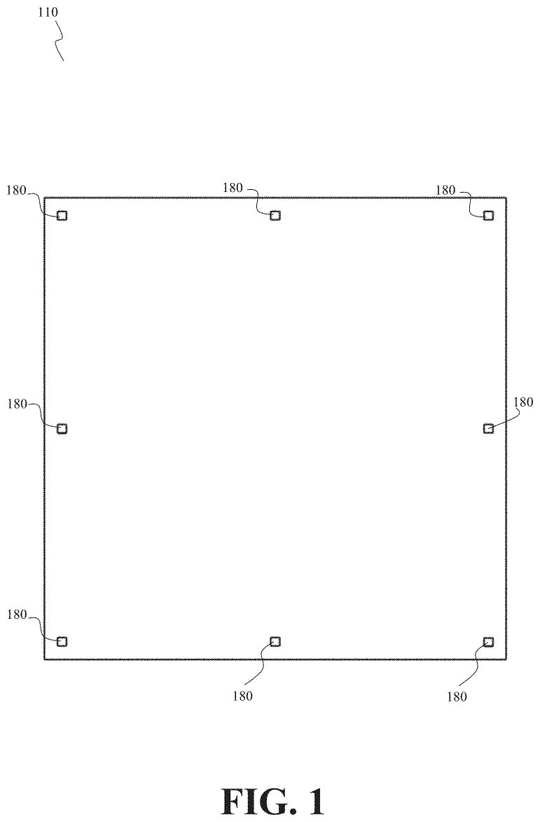

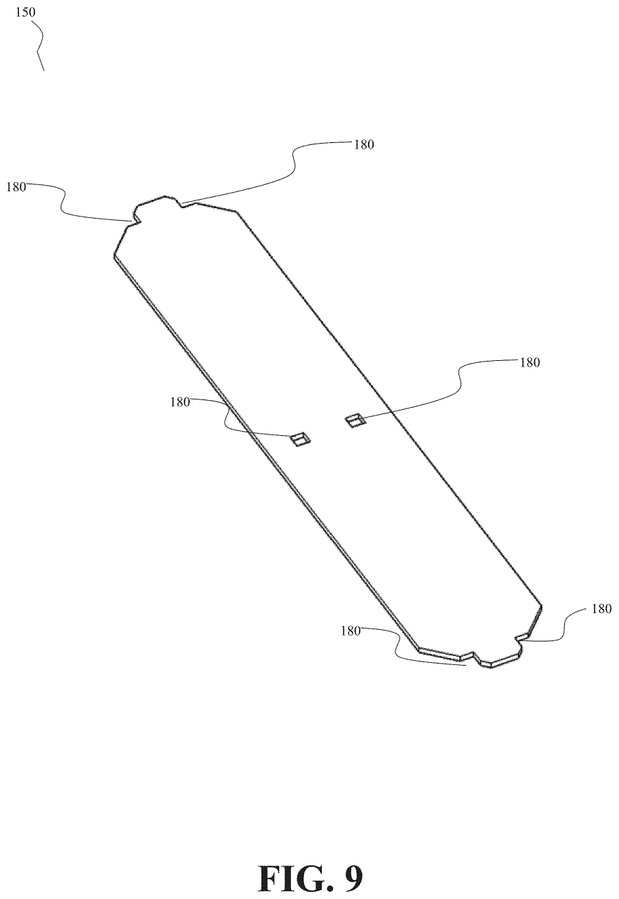

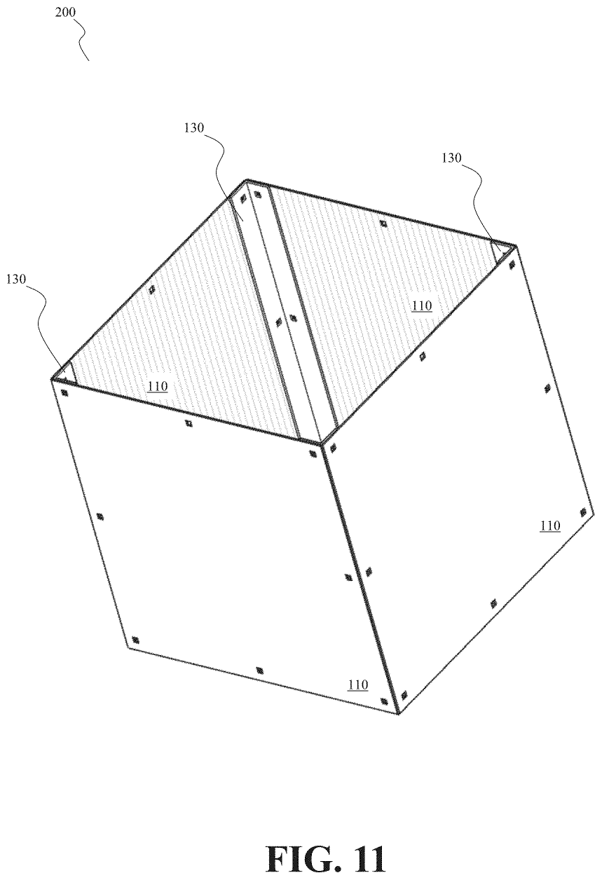

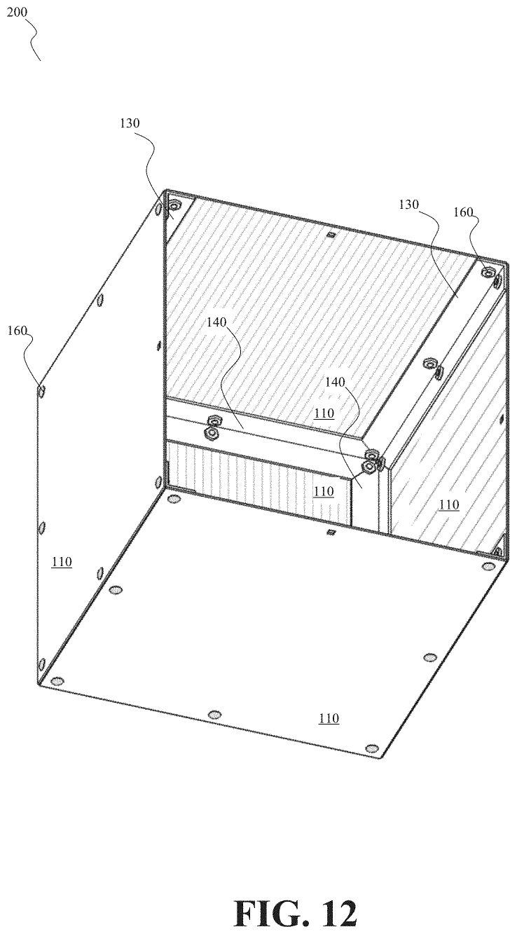

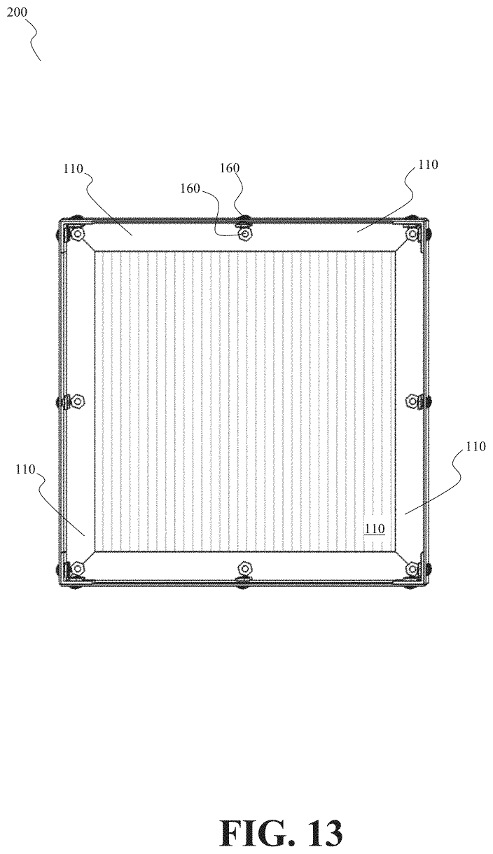

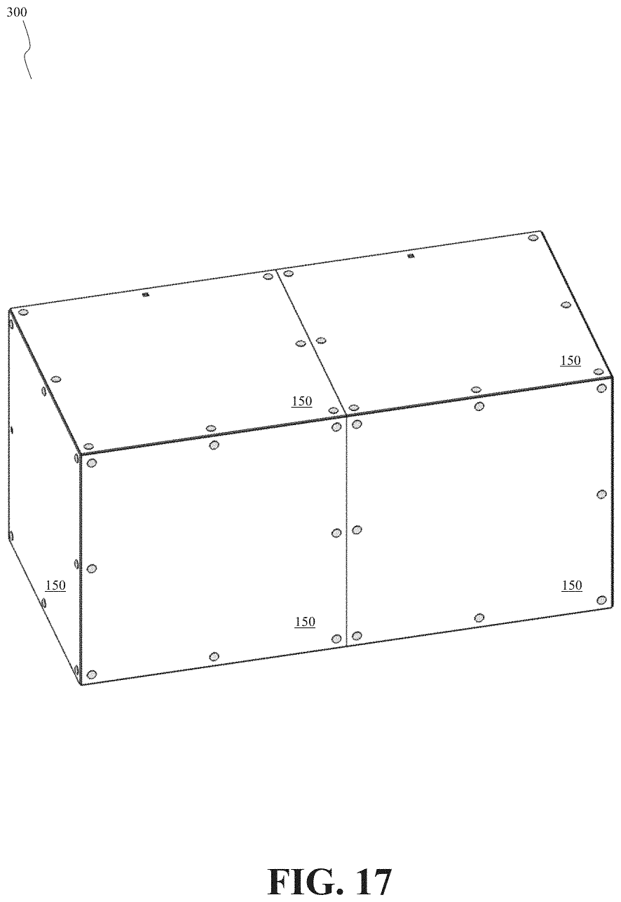

As shown in FIGS. 1-17, the planter box system may be used to build planter boxes in many shapes, sizes, and configurations. The dimensions disclosed herein are exemplary and may be modified and remain within the scope of this disclosure.

As shown in the Figures, a panel 110 may comprise a 20″×20″ square made of mild steel and may have a thickness of 0.105 inches. The mild steel may be, e.g., coreten, stainless, brass, copper, P&O, and/or aluminum. The thickness of the side panel may be modified or adapted for different applications. In general, a thicker panel will be heavier and more expensive, but will also be sturdier.

A panel, and the other components as disclosed herein, may be made from materials other than steel, e.g., composites, other metals, plastics, fiberglass, and many other materials known in the art. Several factors may inform selection of the material or materials for a panel: weather resistance, durability, rigidity, resistance to cracking, brittleness, cost, weight, ease/cost of manufacturing and/or shipping, leeching properties or other circumstances under which a material may contaminate or other otherwise change the soil or other contents of a box or container, aesthetics, safety (e.g., sharp edges, etc.), availability, and any other factor know in the art.

Mild steel may have at least some or all of the following benefits: durability, aesthetics (many types of steel get a desirable rusted look over time), and rigidity. The disclosure herein of materials and dimensions applies to the other panels, connectors, and components described herein.

A panel 110 may be rectangular rather than strictly square, although using a square shape promotes modularity by allowing for use of the same-sized panel for the bottoms and the sides.

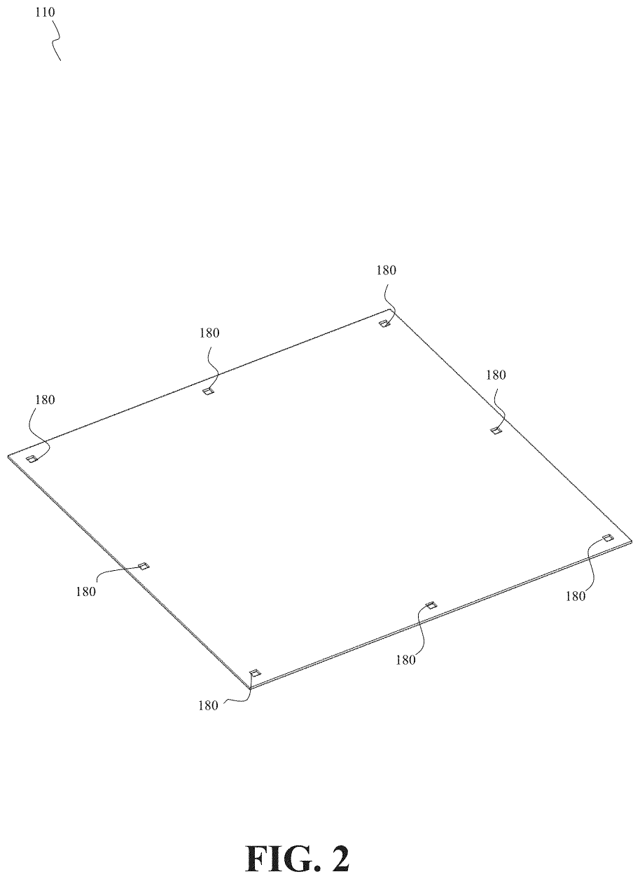

As shown in the figures, panel 110 may have holes 180 for securing the side panel to other panels. In one embodiment, the holes may be configured as shown in FIGS. 1 and 2, with three holes on each side. In one embodiment, the holes may be square. Holes 180 may have other shapes, e.g., circular, regular, or irregular polygons. A polygonal hole, e.g., a square, has the advantage (over a circular hole) of preventing a complementary-shaped bolt from rotating while a nut is being tightened on the other side of the panel.

The holes may be placed in different locations and with different spacing (e.g., the distance between holes) without departing from the scope of this disclosure.

The Figures show an exemplary bottom panel. In one embodiment, the bottom panel may have the same dimensions and thickness as a side panel. The dimensions for a bottom panel may be modified to change the dimensions of the container created out of the bottom panel. As shown in the Figures, each side of a bottom panel may have three holes, and these holes may have dimensions similar to the dimension of the holes in a side panel.

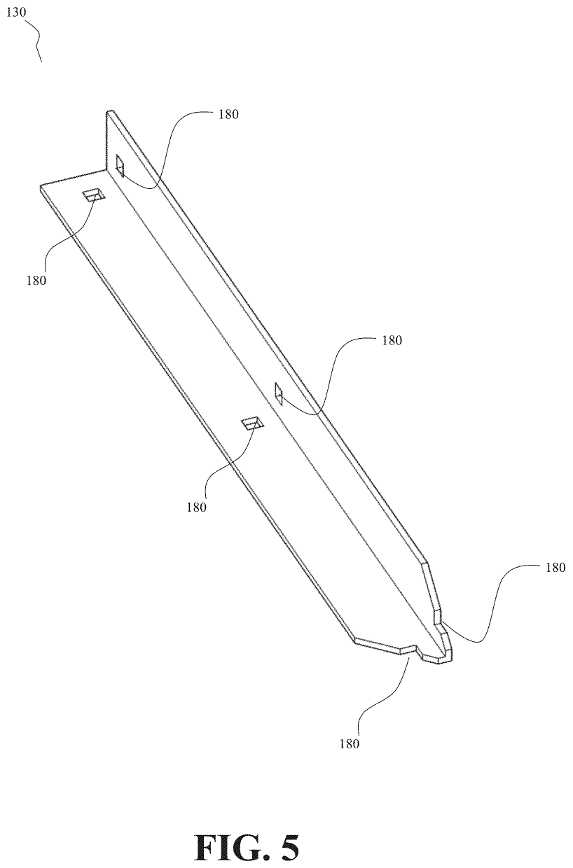

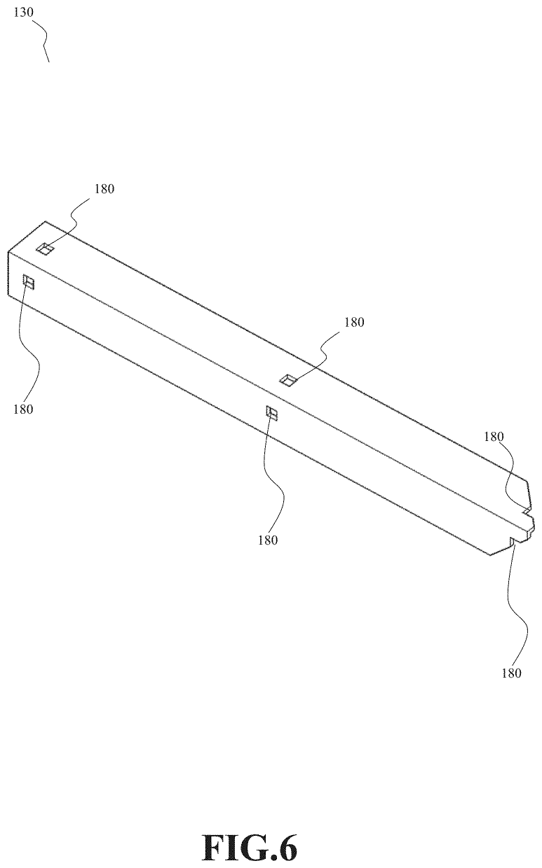

FIGS. 5 and 6 show an exemplary corner-flat-angled connector 130. A corner-flat-angled connector 130 may be used to secure two side panels to each other at a 90-degree angle. Although this disclosure focuses on a container with square and/or rectangular side and bottom panels, other shapes could be used, e.g., triangles, pentagons, etc. If other shapes are used, then the connector pieces must be modified accordingly.

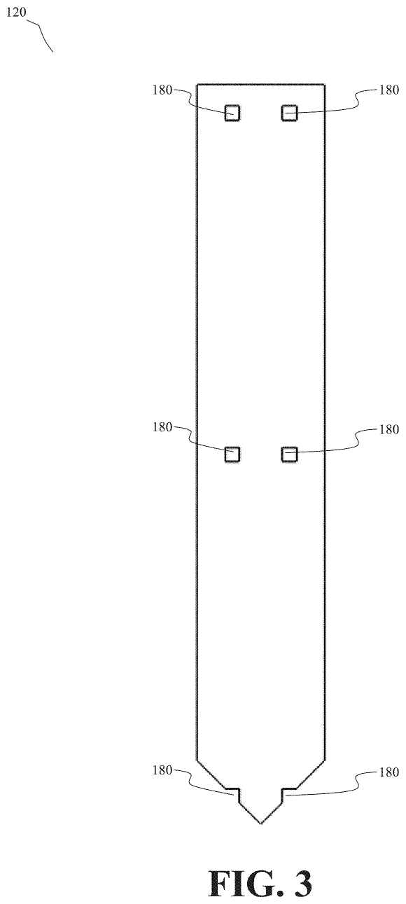

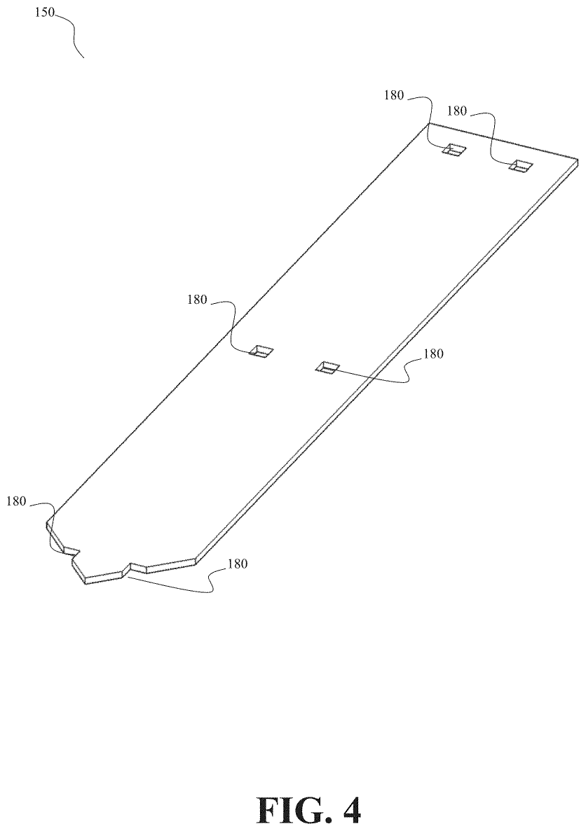

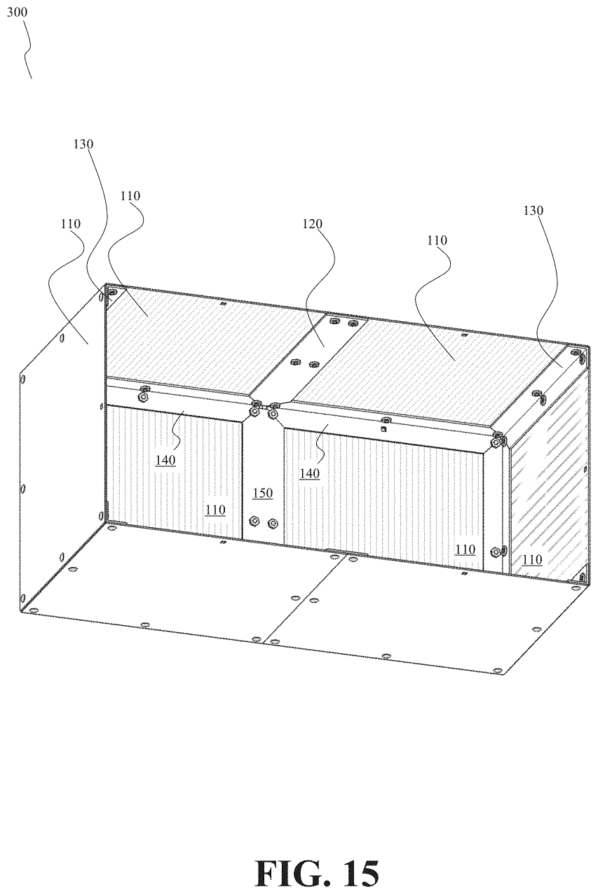

FIGS. 3 and 4 show an exemplary extension-flat-angled connector 120, which may be used for connecting two panels 110 as shown in FIG. 15.

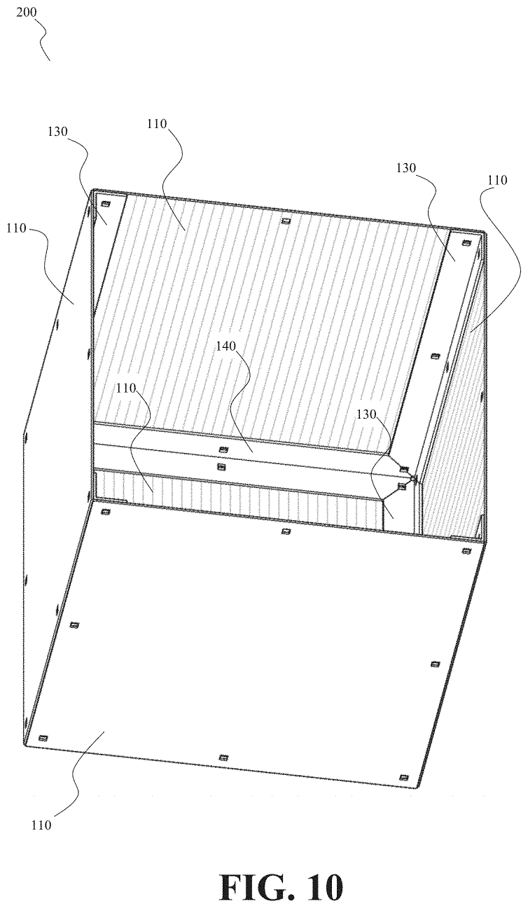

As shown in FIGS. 10-12 and 14-15, corner-flat-angled connector 130 may connect panels 110 to each other using bolt-nut assemblies 160. In one embodiment, bolt-nut assemblies 160 may comprise carriage bolts that may be secured in holes 180 using lock nuts. As is well known in the art, many different types of hardware may be used to secure two panels.

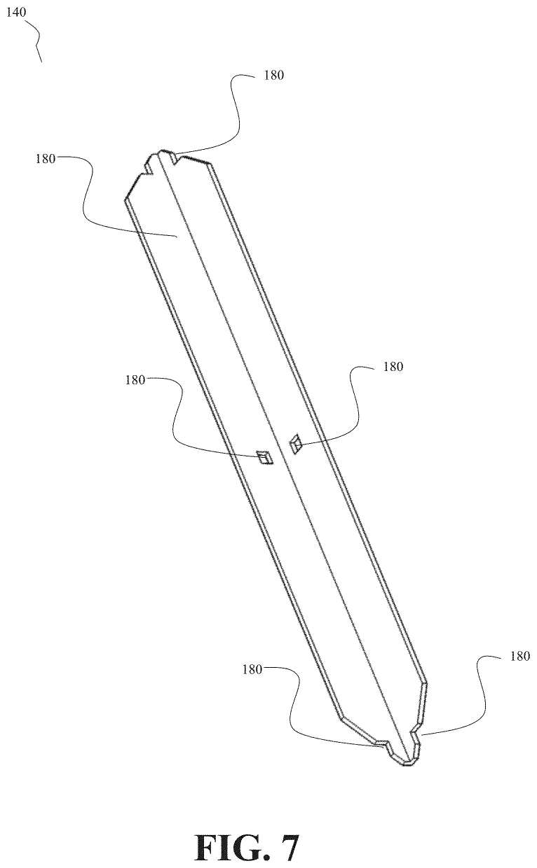

As shown at least in FIGS. 7, 10, 12, and 15, corner-angled-angled connector 140 may secure a panel 110 to another panel 110 using hardware such as one or more bolt-nut assemblies 160.

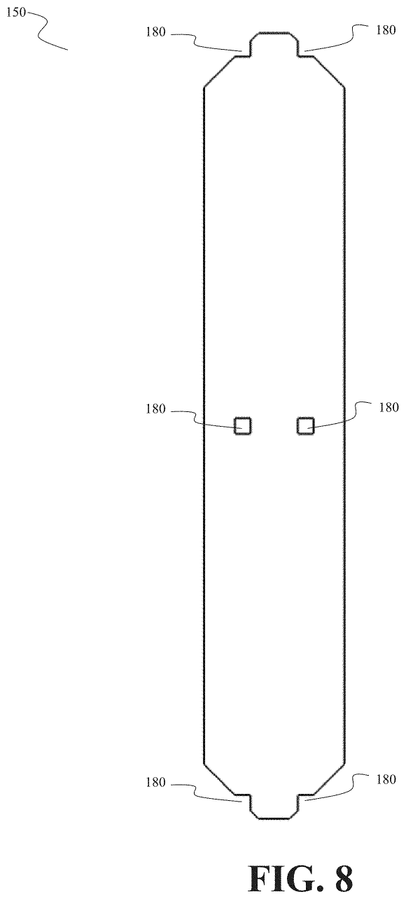

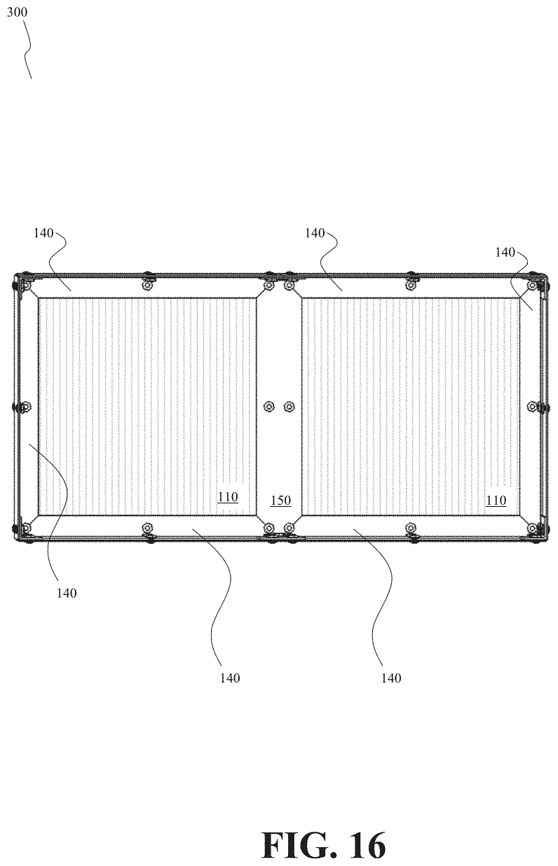

As shown at least in FIGS. 8-9 and 15-16, extension-angled-angled connector 150 may secure panel 110 to another panel 110 using hardware such as bolt-nut assembles 160 This construction may form, as shown in FIGS. 15 and 16, the bottom of a box.

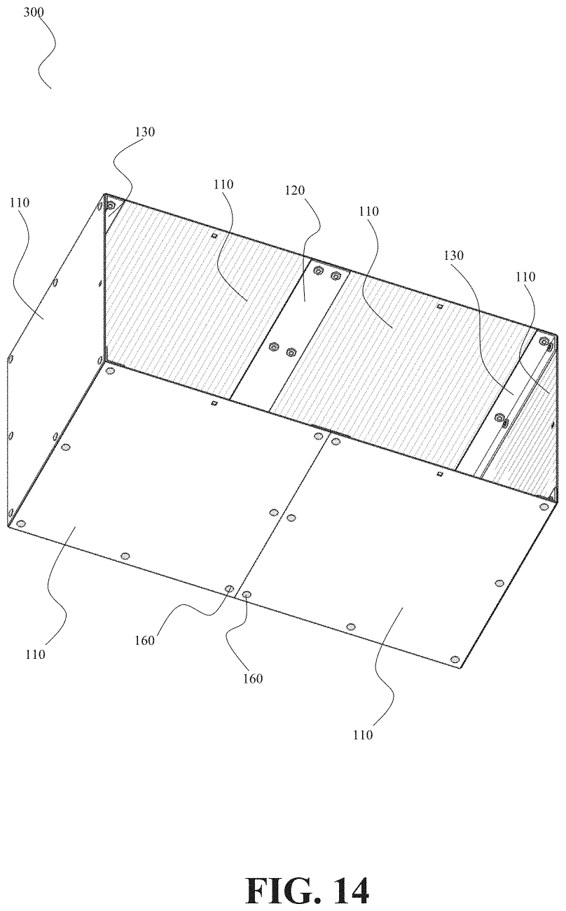

As shown in the Figures, the respective angled ends of extension-flat-angled connector 120, corner-flat-angled connector 130, corner-angled-angled connector 140, and extension-angled-angled connector 150 may be complementary to each other. When used to secure one or more panels 110 as shown in FIGS. 10-17, the complementary shaping results in at least two benefits: First, the complementary shaping improves the snugness and tightness of a fit or connection. Second, the shaping allows for scalability and extendability. A side, corner, or edge is always configured to accept and appropriate panels and/or connector pieces to add to new volume and/or areas to a planter box system as disclosed herein. At least FIGS. 14-17 show an example of the scalability and extendability that results from the design disclosed herein. As a result of this scalability, a planter box may be extended in multiple directions, and to any length or size desired or necessary.

The system disclosed herein has numerous benefits, some of which include:
Customizability of shape and size of a planter box;
Decreased manufacturing cost—e.g., no welding necessary for sides and/or corners;
Ease of assembly;
Ease of disassembly; and
Ease of transportation and storage because system breaks down into components that may be compactly packed.

Drip System Adapter

In one embodiment, a panel 110 may include a hole for inserting an irrigation pipe or tubing, e.g., a drip system line. In some embodiments, this hole may be approximately 0.25″ to accommodate 0.25″ drip system line, which is a standard size for drip system tubing.

Decorative Panels

In one embodiment, the planter system disclosed herein may be configured to receive and secure a decorative panel.

The decorative panels and/or planter box system may additionally include a one or more holes or other mechanisms for lock the decorative panel to the planter box or other item to prevent theft.

Additionally, a lighting system may be incorporated into the planter box system disclosed herein to illuminate the decorative panels.

What is claimed is:

1. An apparatus, comprising:
four rectangular side panels;
a square bottom panel;
four corner-flat-angled-connectors; and
four corner-angled-angled connectors.

2. The apparatus of claim 1, further comprising;
hardware for securing the four corner-flat-angled connectors to the four rectangular side panels; and
hardware for securing the four corner-angled-angled connectors to the square bottom panel and to the four rectangular side panels.

3. The apparatus of claim 2, wherein:
each of the four rectangular side panels, the square bottom panel, the four corner-flat-angled-connectors, and the four corner-angled-angled connectors include at least two holes configured for a bolt;
the hardware for securing the four corner-flat-angled connectors to the four rectangular side panels comprises eight bolt-nut assemblies; and
the hardware for securing the four corner-angled-angled connectors to the square bottom panel and to the four rectangular side panels comprises an additional eight bolt-nut assemblies.

4. The apparatus of claim 1, where each of the four rectangular side panels is square.

5. The apparatus of claim 1, further comprising:
a fifth rectangular side panel and
an extension-angled-angled connector.

6. The apparatus of claim 5, further comprising hardware for hardware for securing the extension-angled-angled connector to two of the rectangular side panels.

7. The apparatus of claim 6, wherein:
at least two of the rectangular side panels include a hole configured for a bolt;
the extension-angled-angled connector includes at least two holes, each of which is configured for a bolt; and
the hardware for securing the extension-angled-angled connector to two of the rectangular side panels comprises two bolt-nut assemblies.

8. The apparatus of claim 5, wherein each of the five rectangular side panels is square.

9. The apparatus of claim 1, further comprising:
a second square bottom panel; and
a extension angled-angled connector;

10. The apparatus of claim 9, further comprising hardware for securing the extension angled-angled connector to the first square bottom panel and to the second square bottom panel.

11. The apparatus of claim 10, wherein:
the first square bottom panel and the second square bottom panel each include a hole configured for a bolt;
the extension-angled-angled connector includes at least two holes configured for a bolt; and
and the extension angled-angled connector includes at least two holes, each of which is configured for a bolt; and
the hardware for securing the extension-angled-angled connector to the first square bottom panel and to the second square bottom panel comprises two bolt-nut assemblies.

12. An apparatus, comprising:
six rectangular side panels;
two square bottom panels;
four corner-flat-angled connectors;
six corner-angled-angled connectors;
two extension-flat-angled connectors; and
an extension-angled-angled connector.

13. The apparatus of claim 12, further comprising hardware for securing the six rectangular side panels, the two square bottom panels, the two square bottom panels, the four corner-flat-angled connectors, the six corner-angled-angled connectors, and the two extension-flat-angled connectors; and the extension-angled-angled connector to each other to form one unit.

14. The apparatus of claim 13, wherein the hardware comprises at least two bolt-nut assemblies.
